(19) United States
(12) Patent Application Publication
(10) Pub. No.: US 2006/0069836 A1
(43) Pub. Date: Mar. 30, 2006

(54) Communication system and method for upgrade of user terminal software and user terminal upgraded by the same

(75) Inventors: Jin-Won Seo, Seoul (KR); Yun-Sang Park, Suwon-si (KR); Tae-In Hyon, Hwaseong-si (KR); Jae-Dong Kim, Seoul (KR); Jeong-Eun Park, Suwon-si (KR); Jin-Young Lee, Suwon-si (KR); Yong Lee, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/037,954

(22) Filed: Jan. 18, 2005

(30) Foreign Application Priority Data
Sep. 9, 2004 (KR) 72234/2004

(51) Int. Cl. G06F 13/00

(52) U.S. Cl. 710/302

(57) ABSTRACT

Disclosed is a communication system for a software upgrade, including a user terminal (UT) for transmitting an IP address assignment request message containing software information of the UT an upgrade-providing server including upgrade data regarding every software of the UT; and a server for determining whether or not software upgrade of the UT is necessary with reference to the software information when the request message is received, and transmitting an address and upgrade information of the upgrade-providing server to the UT when the software upgrade is necessary.

### PRIORITY

This application claims priority to an application entitled “Communication System And Method For Upgrade Of User Terminal Software And User Terminal Upgraded By The Same” filed in the Korean Intellectual Property Office on Sep. 9, 2004 and assigned Serial No. 2004-72234, the contents of which are incorporated herein by reference.

### BACKGROUND OF THE INVENTION

1. Field of the Invention

The present invention relates to a software upgrade of a wireless terminal, and more particularly to a software upgrade of a wireless terminal through a wireless communication network.

2. Description of the Related Art

A wireless mobile Internet system is similar to a cellular network. To upgrade the software of a user terminal (UT) in a cellular network, a centralized server managing the software versions of all user terminals integrally downloads configuration files necessary for a software upgrade to user terminals requiring the software upgrade.

However, it is hard to easily manage such a centralized server. In addition, the centralized server is not well adapted to current cellular networks due to certain characteristics of the server. Further, in contrast with a cellular network, a wireless mobile Internet system can transmit data at a high speed, and each user terminal is based on an Internet protocol (IP) address. Furthermore, since a user terminal, which is a wireless communication apparatus, can use all services on a wired network, it may become necessary to upgrade the software of the user terminal in order to solve security and virus problems.

### SUMMARY OF THE INVENTION

Accordingly, the present invention is to provide a UT and a communication system, and a method for upgrading a software of the user terminal in a wireless mobile Internet network.

According to an aspect of embodiment of the present invention, there is provided a communication system for software upgrade including: a user terminal for transmitting an IP address assignment request message containing software information of the UT; an upgrade-providing server including upgrade data regarding every software of the user terminal; and a server for determining whether software upgrade of the user terminal is necessary with reference to the software information when the request message is received, and transmitting an address and upgrade information of the upgrade-providing server to the UT when the software upgrade is necessary.

According to an aspect of the present invention, there is provided a method for upgrading software of a UT in a communication system including a server, the method including the steps of: inserting software information into a Dynamic Host Configuration Protocol (DHCP) request message when a DHCP processing request is generated and transmitting the DHCP request message; and connecting to an upgrade-providing server based on an address of the upgrade-providing server received from the server, and receiving upgrade data, when it is determined that upgrade of the software is necessary with reference to the software information.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram of a wireless mobile Internet system to which the present invention is applied;

FIG. 2 is a flow diagram illustrating message flow in a wireless mobile Internet system in upgrading software according to an embodiment of the present invention;

FIG. 3 is a block diagram of a UT according to one embodiment of the present invention;

FIG. 4 is a flow chart illustrating control flow in upgrading software of a UT according to an embodiment of the present invention;

FIG. 5 is a view showing a structure of a DHCP request message; and

FIG. 6 is a flow chart illustrating control flow in a DHCP server in upgrading software according to an embodiment of the present invention.

### DETAILED DESCRIPTION OF THE PREFERRED EMBODIMENT

Hereinafter, a preferred embodiment of the present invention will be described with reference to the accompanying drawings. In the following description of the present invention, a detailed description of known functions and configuration incorporated herein will be omitted when it may make the subject matter of the present invention unclear.

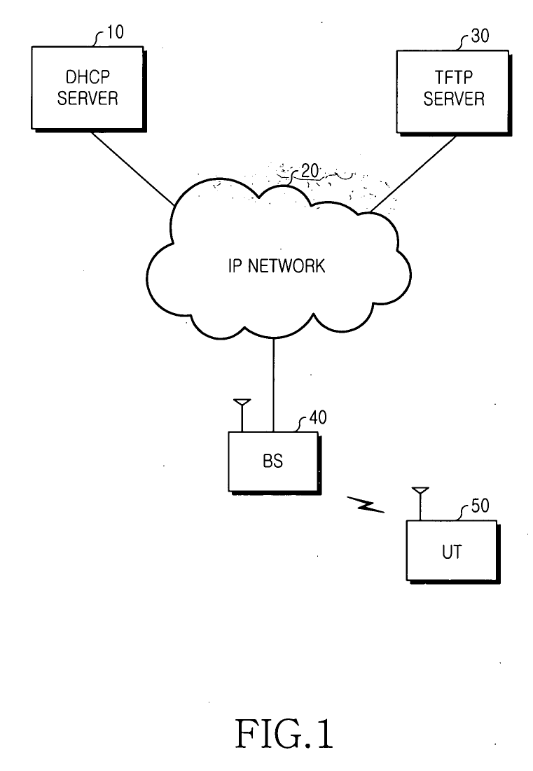

FIG. 1 is a block diagram of a wireless mobile Internet system to which the present invention is applied. The wireless mobile Internet system includes a Dynamic Host Configuration Protocol (DHCP) server 10, an IP network 20, a Trivial File Transfer Protocol (TFTP) server 30, a base station 40 and a UT 50. The UT 50 connects to the IP network 20 through the base station 40 and can communicate with the DHCP server 10 and the TFTP server 30.

The DHCP server 10 assigns an IP address to the user terminal 50 and enables the user terminal 50 to connect to the Internet through the IP network 20. The UT 50 may perform a procedure defined in the DHCP mechanism (IETF RFC 2131) (Internet Engineering Task Force Request For Comment) in order to receive the IP address. When transmitting a DHCP request message requesting the IP address to the DHCP server 10, the user terminal 50 inserts the name of a configuration file into the file field of the DHCP request message and transmits the DHCP request message to the DHCP server 10. Generally, the name of the configuration file includes version information of the configuration file. Further, when receiving the DHCP request message from the UT 50, the DHCP server 10 transmits a DHCP response message for assigning the IP address to the user terminal 50.

The DHCP server 10 determines whether or not the configuration file version of the UT 50 is the latest version with reference to the configuration file version information of the UT 50 contained in the DHCP request message transmitted from the UT 50. The DHCP server 10 periodically communicates with the TFTP server 30 and receives information on a configuration file of the latest version. In other words, when the configuration file has been upgraded, the TFTP server 30 provides the DHCP server 10 with the configuration file information of the latest version.

The DHCP server 10 determines whether or not the configuration file version of the UT 50 contained in the DHCP request message is the latest version with reference to the above configuration file information of the latest version. When the configuration file of the UT 50 is not a configuration file of the latest version, the DHCP server 10 inserts a configuration file name of the latest version into the file field of the DHCP response message and transmits the DHCP response message to the UT 50. Herein, the DHCP response message includes the IP address of the TFTP server 30. The IP address of the TFTP server 30 contained in the DHCP response message is used in a bootstrap process later. Further, the IP address of the TFTP server 30 is used when the UT 50 connects to the TFTP server 30 and receives a configuration file of the latest version.

In contrast, when the configuration file of the user terminal 50 is the configuration file of the latest version, the DHCP server 10 transmits a DHCP response message having the existing construction to the user terminal 50. It should also be noted the term “existing construction” represents that the DHCP server 10 transmits the DHCP response message having the information contained in the DHCP request message (latest version). The UT 50 determines whether the software information contained in the DHCP response message is the latest version or not, so that UT 50 determines the necessity of a software upgrade. Since the information contained in the DHCP request message is the latest version, there is no necessity of the software upgrade. Therefore, the DHCP server 10 transmits the DHCP response message having the information of the latest version received from the UT 50.

When receiving the DHCP response message from the DHCP server 10, the UT 50 determines whether or not the configuration file information of the latest version has been contained in the DHCP response message. That is, the UT 50 determines the necessity of a software upgrade. When the configuration file information of the latest version is contained in the DHCP response message, the UT 50 connects to the TFTP server 30 by means of the IP address of the TFTP server 30 contained in the DHCP response message. Herein, communication between the TFTP server 30 and the user terminal 50 may be performed by the procedure defined in a TFTP mechanism (IETF RFC 783 and IETF RFC 1350. The TFTP server 30 does not require a user account and password when the user terminal 50 connects to the TFTP server 30.

The UT 50, having connected to the TFTP server 30, requests that the TFTP server 30 transmit the configuration file of the latest version necessary for the UT 50. When receiving the transmission request of the configuration file, the TFTP server 30 generates a new configuration file necessary for the UT 50 with reference to the transmission request and transmits the generated configuration file to the user terminal 50. Accordingly, the UT 50 receives the configuration file of the latest version necessary for the software upgrade from the TFTP server 30 and decodes the received configuration file, thereby performing the software upgrade.

Meanwhile, the UT 50 periodically communicates with the DHCP server 10 according to the DHCP mechanism (IETF RFC 2131). In order to continuously use the IP address assigned from the DHCP server 10, the UT 50 must take a certification from the DHCP server 10. Thus, the UT 50 transmits the DHCP request message to the DHCP server 10 and the DHCP server 10 sends an ACK message or an NACK message in response to the DHCP request message. Even in such a communication with the DHCP server 10, the UT 50 inserts the name of the configuration file into the file field of the DHCP request message and transmits the DHCP request message to the DHCP server 10. Accordingly, the DHCP server 10 can periodically monitor the state of a software upgrade. As described above, when it is determined that an upgrade is necessary in consideration of the configuration file information transmitted from the UT 50, the DHCP server 10 transmits the IP address of the TFTP server 30 and configuration file information of the latest version necessary for the upgrade through an ACK message or an NACK message.

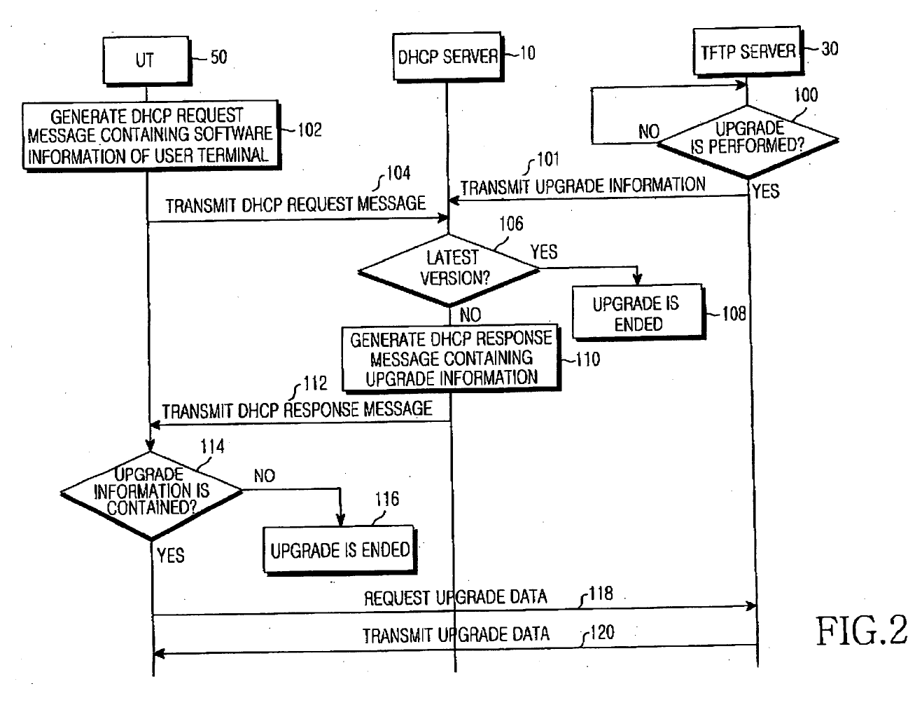

Hereinafter, message flow among the DHCP server 10, the TFTP server 30 and the UT 50 in upgrading the software of the UT 50 will be described with reference to FIG. 2.

Referring to FIG. 2, in step 102, the 50 generates a DHCP request message requesting an IP address when it is necessary to access the Internet. In addition, the 50 can generate a DHCP request message requesting certification for continuously using an IP address assigned from the DHCP server 10.

Herein, the UT 50 generates the DHCP request message containing configuration file information. Such configuration file information can be inserted into the file field of the DHCP request message and the configuration file information can include a configuration file name, a configuration file version, etc. Further, the UT 50 transmits the DHCP request message to the DHCP server 10 in step 104. When receiving the DHCP request message from the UT 50, the DHCP server 10 determines whether or not the configuration file version of the UT 50 is the latest version with reference to the configuration file information of the UT 50 contained in the DHCP request message, in step 106.

Since the DHCP server 10 periodically communicates with the TFTP server 30 and receives information on the configuration file of the latest version, the DHCP server 10 is assumed to have already known the configuration file information of the latest version. In detail, the TFTP server 30 determines whether or not the configuration file has been upgraded in step 100. When the configuration file has been upgraded, the TFTP server 30 provides the DHCP server 10 with the configuration file information of the latest version, in step 101.

Meanwhile, when the configuration file of the UT 50 is not the configuration file of the latest version, the DHCP server 10 generates a DHCP response message containing the configuration file information of the latest version in step 110. In addition, when receiving the DHCP request message requesting the certification for using the IP address, the DHCP server 10 generates an ACK message or an NACK message.

In addition, when the configuration file of the UT 50 is the configuration file of the latest version, the DHCP server 10 proceeds to step 108 and ends the upgrade process.

For example, the DHCP server 10 inserts the configuration file information of the latest version into the file field of the DHCP response message. The DHCP response message includes the IP address of the TFTP server 30. In addition, the DHCP server 10 may insert the configuration file information of the latest version into the ACK message or the NACK message. In such a case, it is assumed that the IP address of the TFTP server 30 has been provided to the UT 50 during the initial assignment of an IP address. However, the DHCP server 10 may provide the IP address of the TFTP server 30 to the UT 50 through the ACK message or the NACK message. The IP address of the TFTP server 30 enables the UT 50 to connect to the TFTP server 30 and to receive the configuration file of the latest version. Next, the DHCP server 10 transmits the DHCP response message to the UT 50 in step 112.

When receiving the DHCP response message from the DHCP server 10, the UT 50 determines whether or not the configuration file information of the latest version has been contained in the DHCP response message, in step 114. When the configuration file information of the latest version has been contained in the DHCP response message, the UT 50 connects to the TFTP server 30 by means of the IP address of the TFTP server 30 contained in the DHCP response message in step 118 and requests that the TFTP server 30 transmit the configuration file of the latest version to the UT 50. When receiving the transmission request of the configuration file from the UT 50, the TFTP server 30 generates and transmits the configuration file of the latest version necessary for the user terminal 50 in step 120. Accordingly, the user terminal 50 receives the configuration file of the latest version necessary for a software upgrade from the TFTP server 30 and decodes the received configuration file, thereby performing the software upgrade. Alternatively, if the configuration file information of the latest version is not contained in the DHCP response message in step 114, the UT proceeds to step 116 and ends the upgrade process.

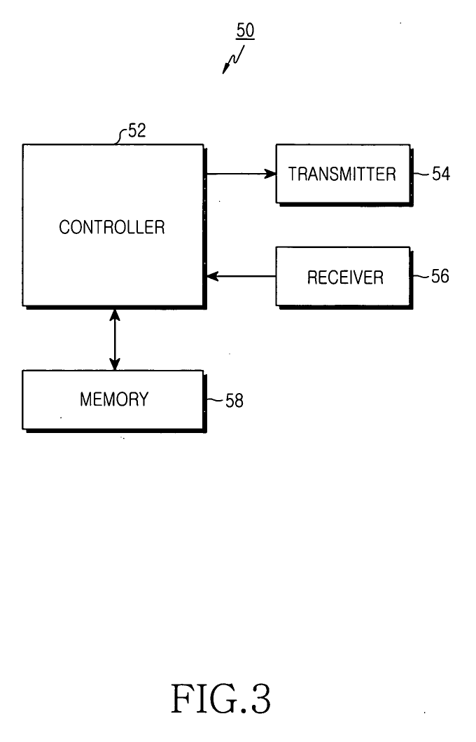

Hereinafter, the construction and the operation of the user terminal 50 according to one embodiment of the present invention will be described with reference to FIG. 3.

The UT 50 includes a controller 52, a transmitter 54, a receiver 56 and a memory 58. When a DHCP processing request is generated, the controller 52 generates a DHCP request message and transmits the DHCP request message to the DHCP server 10 through the transmitter 54. As described above, in generating the DHCP request message, the controller 52 inserts configuration file information into the file field of the DHCP request message and transmits the DHCP request message to the DHCP server 10. Meanwhile, when receiving a DHCP response message from the DHCP server 10 through the receiver 56, the controller 52 determines whether or not configuration file information of the latest version has been contained in the DHCP response message. When the configuration file information of the latest version has been contained in the DHCP response message, the controller 52 connects to the TFTP server 30, receives the configuration file of the latest version from the TFTP server 30, decodes the received configuration file, thereby performing a software upgrade. Furthermore, the controller 52 stores the configuration file and related information in the memory 58.

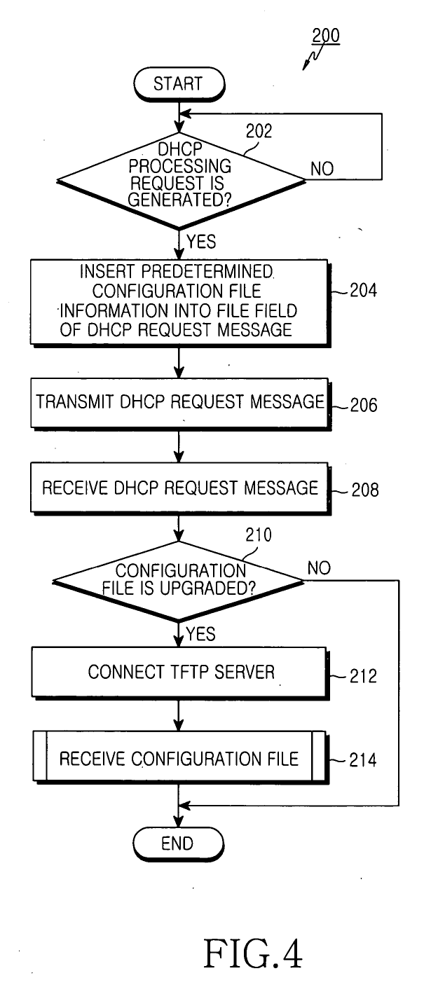

Hereinafter, control flow in the software upgrade in the UT 50 constructed as described above will be described with reference to FIG. 4.

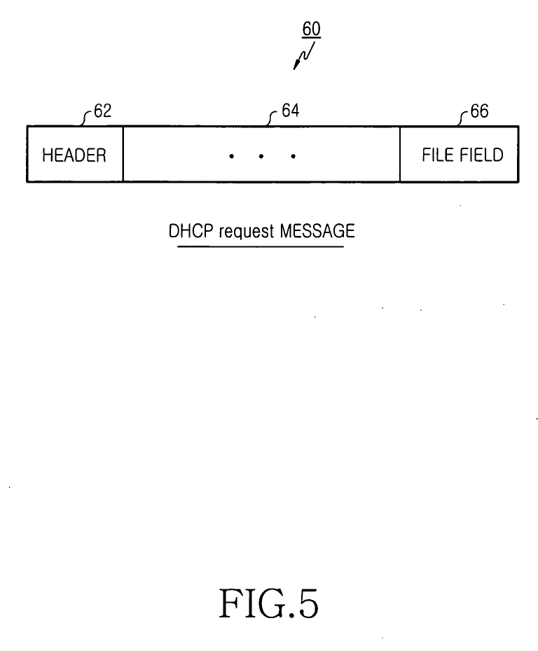

Referring to FIG. 4, in step 202, the UT 50 determines whether or not a DHCP processing request is generated. When requesting an IP address or a certification for using an IP address assigned in advance, the UT 50 requests DHCP processing. When the DHCP processing request is generated, the UT 50 inserts predetermined configuration file information into the file field of a DHCP request message in step 204. FIG. 5 shows the structure of such a DHCP request message. Referring to FIG. 5, the DHCP request message 60 includes a header 62, a file field 66, and other file fields 64. According to an embodiment of the present invention, the file field 66 of the DHCP request message 60 includes configuration file information. The configuration file information may include the configuration file name and, the configuration file version, etc., as described above. That is, the UT 50 generates the DHCP request message including the configuration file information in step 204 and transmits the generated DHCP request message to the DHCP server 10 in step 206. Next, when receiving a DHCP response message from the DHCP server 10 in step 208, the UT 50 determines whether or not configuration file information of the latest version has been contained in the DHCP response message in step 210.

That is, in step 210, the UT 50 determines whether or not a configuration file has been upgraded. When the configuration file has been upgraded, the UT 50 connects to the TFTP server 30 by means of the IP address of the TFTP server 30 contained in the DHCP response message and requests that the TFTP server 30 transmit a configuration file of the latest version necessary for the UT 50, in step 212. Further, when the TFTP server 30 transmits the configuration file of the latest version necessary for the UT 50 according to the transmission request of the configuration file of the latest version, the UT 50 receives the configuration file in step 214.

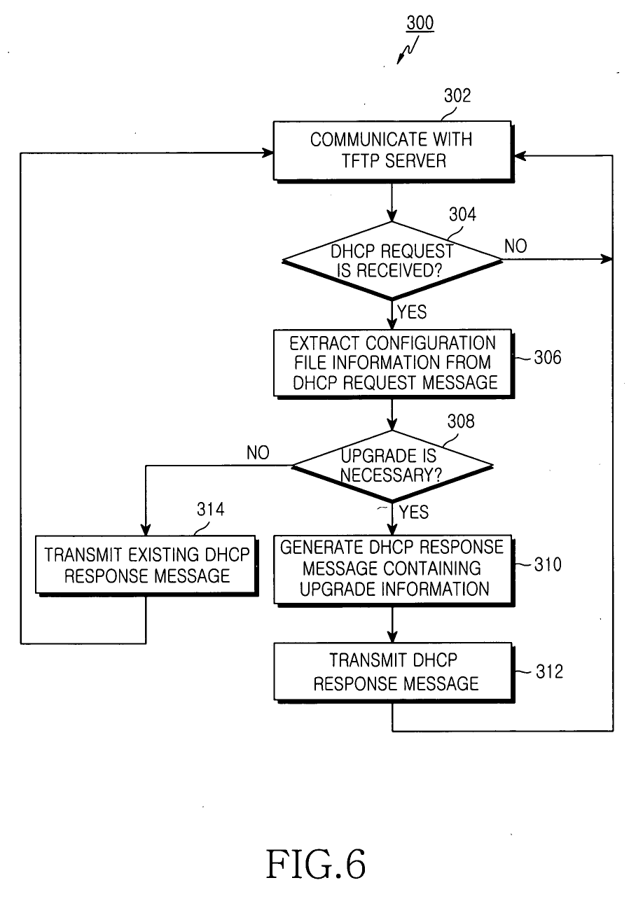

Hereinafter, control flow in the DHCP server 10 when a software of the UT 50 is upgraded will be described with reference to FIG. 6.

Referring to FIG. 6, in step 302, the DHCP server 10 periodically communicates with the TFTP server 30 and receives information on a configuration file of the latest version. When the configuration file is upgraded, the TFTP server 30 provides the DHCP server 10 with the configuration file information of the latest version.

Further, in step 304, the DHCP server 10 determines whether or not a DHCP request message is received from the UT 50. The UT 50 generates the DHCP request message requesting an IP address for Internet access or certification for using an already assigned IP address and transmits the generated DHCP request message to the DHCP server 10.

When receiving the DHCP request message from the UT 50, the DHCP server 10 extracts the configuration file information of the UT 50 from the DHCP request message in step 306. Further, the DHCP server 10 determines whether or not the version of the configuration file of the UT 50 is the latest version with reference to the extracted configuration file information. That is, the DHCP server 10 determines whether or not a software upgrade is necessary in the UT 50. When it is determined that the software upgrade is not necessary in the UT 50, the DHCP server 10 transmits the existing DHCP response message to the UT 50, in step 314.

Meanwhile, when the configuration file of the UT 50 is not a configuration file of the latest version, the DHCP server 10 generates a DHCP response message containing configuration file information of the latest version in step 310. In addition, when receiving the DHCP request message requesting certification for using an IP address, the DHCP server 10 generates an ACK message or an NACK message.

That is, the DHCP server 10 inserts the configuration file information of the latest version into the file field of the DHCP response message. Further, the DHCP server 10 inserts the IP address of the TFTP server 30 into the DHCP response message and transmits the DHCP response message to the UT 50 in step 312.

The present invention simplifies and enhances the management of a centralized server when performing a software upgrade of a UT by a centralized server in a cellular network.

Furthermore, in the present invention, the software of a UT is upgraded through a DHCP server managing the configuration file information of the user terminal and a TFTP server storing a configuration file of the latest version, thereby reducing the load and enabling easy management as compared with a case in which software is upgraded through one server.

In the aforementioned embodiment, a DHCP server assigns an IP address. Moreover, any server capable of assigning an IP address can be used. Additionally, in the aforementioned embodiment, a TFTP server transmits data for software upgrade. Furthermore, any server capable of transmitting data to a UT can be used.

Although a preferred embodiment of the present invention has been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. A communication system for software upgrade comprising:
a user terminal (UT) for transmitting an Internet Protocol (IP) address assignment-request message containing software information of the user terminal;
an upgrade-providing server including upgrade data regarding software of the UT; and
a first server for determining whether a software upgrade of the UT is necessary with reference to the software information when the request message is received, and transmitting an address and upgrade information of the upgrade-providing server to the user terminal when the software upgrade is necessary.

2. The communication system for software upgrade as claimed in claim 1, wherein the UT receives the address of the upgrade-providing server from the first server, connects to the corresponding upgrade-providing server, and receives the upgrade data.

3. The communication system for software upgrade as claimed in claim 1, wherein the UT receives the upgrade information of the upgrade-providing server from the first server, connects to the corresponding upgrade-providing server, and receives the upgrade data.

4. The communication system for software upgrade as claimed in claim 2, wherein the UT receives the upgrade information of the upgrade-providing server from the first server, connects to the corresponding upgrade-providing server, and receives the upgrade data.

5. The communication system for software upgrade as claimed in claim 1, wherein the upgrade-providing server provides the first server with information on the software upgrade when the software upgrade is performed.

6. The communication system for software upgrade as claimed in claim 1, wherein the upgrade information includes a name of a configuration file of a latest software version.

7. The communication system for software upgrade as claimed in claim 1, wherein the software includes a configuration file.

8. A user terminal (UT) for upgrading software in a communication system, the UT comprising:
a controller for generating and transmitting a Dynamic Host Configuration Protocol (DHCP) request message containing software information when a DHCP processing request is generated, receiving a DHCP response message containing an address of an upgrade-providing server, and connecting to the upgrade-providing server to receive upgrade data; and
a memory for storing the software and related information.

9. The user terminal as claimed in claim 6, wherein the DHCP response message further contains upgrade information of an upgrade-providing server.

10. The user terminal as claimed in claim 8, wherein the upgrade-providing server includes a Trivial File Transfer Protocol (TFTP) server.

11. A method for upgrading software of a user terminal (UT) in a communication system including a server, the method comprising the steps of:
inserting software information into a Dynamic Host Configuration Protocol (DHCP) request message when a DHCP processing request is generated, and transmitting the DHCP request message; and
connecting to an upgrade-providing server based on an address of the upgrade-providing server received from the server, and receiving upgrade data, when it is determined that upgrade of the software is necessary with reference to the software information.

12. The method as claimed in claim 11, further comprising the steps of:
determining by the server whether upgrading the software of the UT is necessary with reference to the software information when a DHCP request message is received from the UT; and
transmitting by the server the address of the upgrade-providing server, which provides the upgrade data, to the UT when the software upgrade is necessary.

13. The method as claimed in claim 11, further comprising the step of providing by the upgrade-providing server information on the software upgrade to the server when the software upgrade is performed.

14. The method as claimed in claim 11, wherein the upgrade data includes a name of a configuration file of a latest software version.

15. The method as claimed in claim 12, wherein the server includes a Dynamic Host Configuration Protocol (DHCP) server.

16. The method as claimed in claim 12, wherein the upgrade-providing server providing the upgrade data includes a Trivial File Transfer Protocol (TFTP) server.

17. The method as claimed in claim 11, wherein the upgrade-providing server provides the server with configuration file information of a latest software version when a configuration file has been upgraded.

18. The method as claimed in claim 12, further including the step of:
transmitting by the server upgrade information of the upgrade-providing server, which provides the upgrade data, to the UT when the software upgrade is necessary.
